(19) United States
(12) Patent Application Publication
(10) Pub. No.: US 2012/0120794 A1
(43) Pub. Date: May 17, 2012

(54) METHOD AND APPARATUS FOR CONTROLLING TRAFFIC

(75) Inventors: Gyung-chul SIHN, Daejeon (KR); Pyeong Jung SONG, Daejeon (KR); Won-lk KIM, Daejeon (KR); Woo Goo PARK, Daejeon (KR)

(73) Assignee: ELECTRONICS AND TELECOMMUNICATIONS RESEARCH INSTITUTE, Daejeon (KR)

(21) Appl. No.: 13/295,116

(22) Filed: Nov. 14, 2011

(30) Foreign Application Priority Data
Nov. 16, 2010 (KR) 10-2010-0113938

(51) Int. Cl. H04L 12/26

(52) U.S. Cl. 370/230

(57) ABSTRACT

A method for controlling traffic in a mobile communication network is provided. A traffic control apparatus checks locations of a calling terminal and a receiving terminal, and determines whether to perform terminal-to-terminal direct communication based on the locations of the calling terminal and the receiving terminal. A base station of the calling terminal and a base station of the receiving terminal instruct the calling terminal and the receiving terminal to perform the terminal-to-terminal direct communication when the terminal-to-terminal direct communication is determined to be performed.

### CROSS-REFERENCE TO RELATED APPLICATION

This application claims priority to and the benefit of Korean Patent Application No. 10-2010-0113938 filed in the Korean Intellectual Property Office on Nov. 16, 2010, the entire contents of which are incorporated herein by reference.

### BACKGROUND

(a) Field

The present invention relates to a traffic control method and apparatus.

(b) Description of the Related Art

In a mobile communication network, control signals and user traffic are transmitted to a terminal via the same network path. When the terminal performs a handover, a connection is newly configured from an initially accessed network to a handover network, and the user traffic is transferred to the handover network. Further, control signals and user traffic of a service such as a voice over internet protocol (VoIP) service provided in the mobile communication network are transferred to the terminal via a base station.

It is anticipated that the user traffic will be continuously increased because of the increase of multimedia data. Therefore, a network load due to the increase of the user traffic rises, and build-up costs for expanding the network are also increased.

Further, while a mobile communication service provider can use self-organizing network (SON) technology and green radio technology to reduce the build-up costs, capital expenditures (CAPEXs) and operating expenditures (OPEX) are increased to transfer the control signals and the traffic via the same network. As a result, high mobile communication fees prevent the mobile communication service from being stimulated, and a battery usage of the terminal is increased for data transmission between the terminal and the base station.

### SUMMARY

Embodiments of the present invention provide a traffic control method and apparatus for reducing a load of a mobile communication network.

According to an embodiment of the present invention, a method for controlling traffic in a traffic control apparatus of a mobile communication network is provided. The method includes checking locations of a calling terminal and a receiving terminal, determining whether to perform a terminal-to-terminal direct communication based on the locations of the calling terminal and the receiving terminal, and requesting a first base station of the calling terminal and a second base station of the receiving terminal that the first base station and the second base station respectively instruct the calling terminal and the receiving terminal to perform the terminal-to-terminal direct communication when determining to perform the terminal-to-terminal direct communication.

The traffic control apparatus may determine to perform the terminal-to-terminal direct communication when the calling terminal and the receiving terminal are located in a same cell. In this case, the first base station and the second base station may be the same base station.

The traffic control apparatus may determine to perform the terminal-to-terminal direct communication when the calling terminal and the receiving terminal are located in different cells and are located within a direct propagation distance range.

When requesting the first base station and the second base station, the traffic control apparatus may transmit information on the receiving terminal to the first base station, and transmit information on the calling terminal to the second base station. In this case, the method may further include receiving a request for authentication and location check of the calling terminal and the receiving terminal from the first base station, and transmitting a request for a call receipt to the second base station.

User traffic between the calling terminal and the receiving terminal may be directly transmitted between the calling terminal and the receiving terminal without passing through the first base station and the second base station when the terminal-to-terminal direct communication is performed.

According to another embodiment of the present invention, a method of controlling traffic in a terminal of a mobile communication network is provided. The method includes transmitting a request for a connection with a receiving terminal to a base station, receiving an instruction for terminal-to-terminal direct communication from the base station, switching to a terminal-to-terminal direct communication state by exchanging messages for the terminal-to-terminal direct communication with the receiving terminal, and directly transmitting or receiving user traffic to or from the receiving terminal without using the base station.

The instruction may be transmitted when a gateway of the mobile communication network determines to perform the terminal-to-terminal direct communication based on locations of the terminal and the receiving terminal. The terminal-to-terminal direct communication may be determined to be performed when the terminal and the receiving terminal are located in a same cell or when the terminal and the receiving terminal are located in different cells and are located within a direct propagation distance range.

When receiving the instruction, the terminal may receive information on the receiving terminal.

When switching to the terminal-to-terminal direct communication state, the terminal may transmit a connection attempt message for the terminal-to-terminal direct communication to the receiving terminal, and receive a response message to the connection attempt message from the receiving terminal.

When switching to the terminal-to-terminal direct communication state, the terminal may receive a connection attempt message for the terminal-to-terminal direct communication from the receiving terminal, and transmit a response message to the connection attempt message to the receiving terminal.

The method may further include transmitting a connection release message for the terminal-to-terminal direct communication to the receiving terminal, and receiving a response message to the connection release message from the receiving terminal.

The method may further include receiving a connection release message for the terminal-to-terminal direct communication from the receiving terminal, and transmitting a response message to the connection release message to the receiving terminal.

According to yet another embodiment of the present invention, an apparatus for controlling traffic in a mobile communication network is provided, and the apparatus includes a connection establishment unit and a transceiver. The connection establishment unit checks locations of a calling terminal and a receiving terminal, and determines whether to perform terminal-to-terminal direct communication based on the locations of the calling terminal and the receiving terminal. The transceiver requests a first base station of the calling terminal and a second base station of the receiving terminal that the first base station and the second base station respectively instruct the calling terminal and the receiving terminal to perform the terminal-to-terminal direct communication when the connection establishment unit determines to perform the terminal-to-terminal direct communication.

The connection establishment unit may determine to perform the terminal-to-terminal direct communication when the calling terminal and the receiving terminal are located in a same cell.

The connection establishment unit may determine to perform the terminal-to-terminal direct communication when the calling terminal and the receiving terminal are located in different cells and are located within a direct propagation distance range.

The transceiver may transmit information on the receiving terminal to the first base station, and transmit information on the calling terminal to the second base station.

### BRIEF DESCRIPTION OF THE DRAWINGS

FIG. 1 and FIG. 2 are schematic drawings showing a mobile communication system according to embodiments of the present invention.

FIG. 3 is a schematic flowchart showing a traffic control method according to an embodiment of the present invention.

FIG. 4 is schematic block diagram showing a traffic control apparatus according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, and so on, or may include all or some functions thereof.

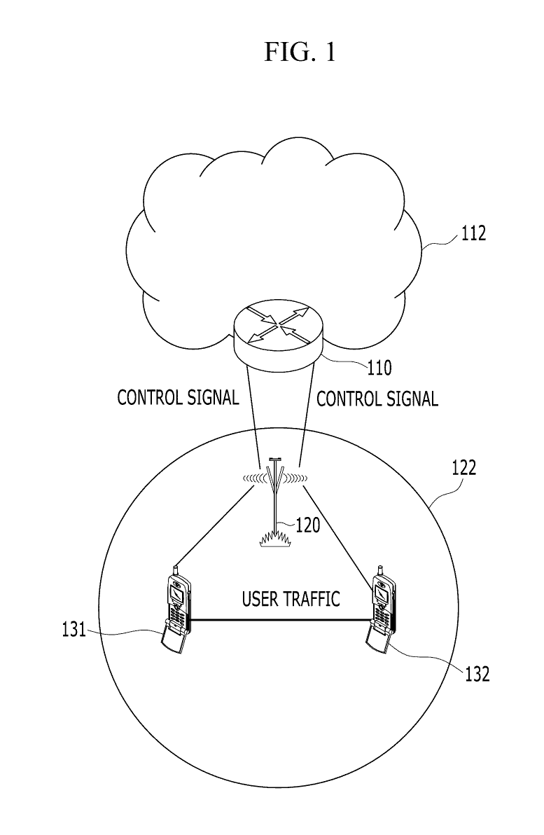

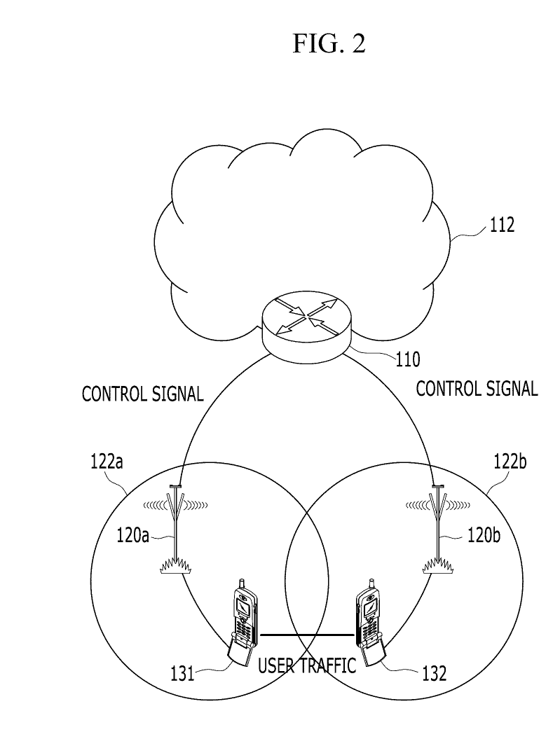

FIG. 1 and FIG. 2 are schematic drawings showing a mobile communication system according to embodiments of the present invention.

Referring to FIG. 1, the mobile communication system includes a gateway 110, a base station 120, and terminals 131 and 132.

The gateway 110 is connected to a mobile communication network 112. The gateway 110 performs authentication on the terminals and checks locations of the terminals. Further, the gateway 110 transfers information on the terminal 131 or 132 to the opponent terminal 132 or 131 for terminal-to-terminal direct communication, thereby instructing a connection establishment for the direct communication.

The base station 120 connects the terminals 131 and 132 within its coverage, i.e., a cell 122, to the gateway 110 of the mobile communication network 112, and controls the wireless connection establishment for the terminals 131 and 132.

The terminals 131 and 132 access the mobile communication network 112 via the base station 120 and the gateway 110, and each performs the terminal-to-terminal direct communication with its opponent terminal.

When the calling terminal 131 calls the receiving terminal 132, a connection establishment signal is transferred from the calling terminal 131 to the receiving terminal 132 via the base station 120, the gateway 110, and the base station 120, and then the connection is established. The gateway 110 checks the location of the receiving terminal 132, and controls the terminals 131 and 132 to allow user traffic to be directly communicated between the calling terminal 131 and the receiving terminal 132 without passing through the base station 120 and the gateway 110 when the terminals 131 and 132 are located in the same cell.

Referring to FIG. 2, a calling terminal 131 and a receiving terminal 132 are located in different cells 122a and 122b. In this case, when the calling terminal 131 calls the receiving terminal 132, a connection establishment signal is transferred from the calling terminal 131 to the receiving terminal 132 via a base station 120a to which the calling terminal 131 belongs, a gateway 110, and a base station 120b to which the receiving terminal 132 belongs. The gateway 110 checks locations of the terminals 131 and 132 and a direct propagation distance between the two terminals. The gateway 110 controls the terminals 131 and 132 to perform the terminal-to-terminal direct communication when the direct propagation distance is within a direct propagation distance range.

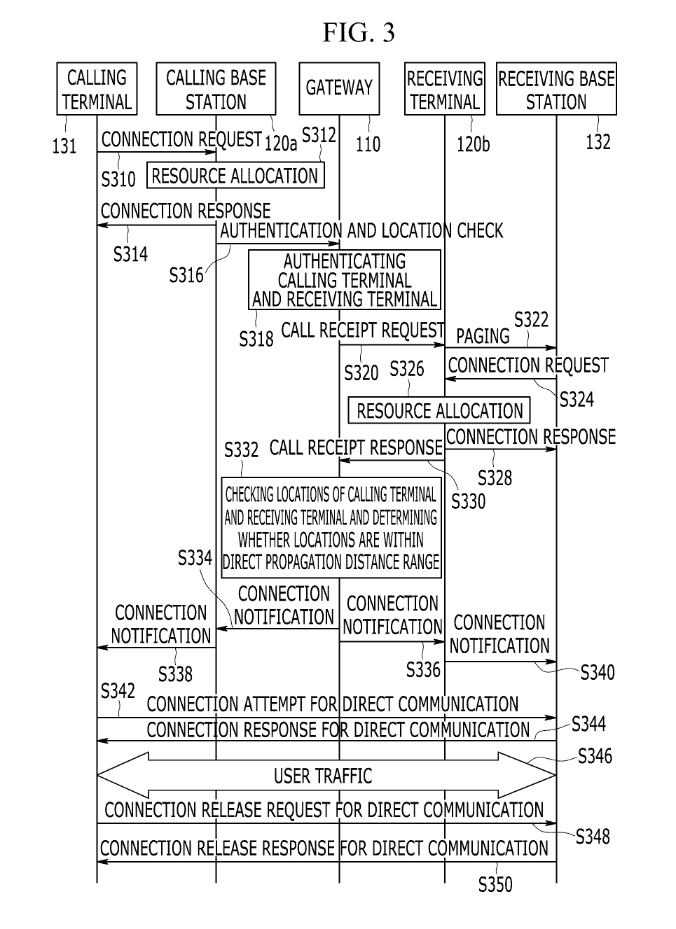

FIG. 3 is a schematic flowchart showing a traffic control method according to an embodiment of the present invention.

Referring to FIG. 3, when a calling terminal 131 calls a receiving terminal 132, the calling terminal 131 transmits a connection request to a calling base station 120a (S310). The calling base station 120a allocates resources to the calling terminal 131 (S312), and notifies the calling terminal 131 of a result of resource allocation as a response of the connection request (S314). The calling base station 120a transmits a request for authentication and location check of the calling terminal 131 and the receiving terminal 132 to a gateway 110 of a mobile communication network (S316). The gateway 110 authenticates the calling terminal 131 and the receiving terminal 132 (S318), and transmits a request for a call receipt to a receiving base station 120b (S320). The receiving base station 120b broadcasts a receipt paging to terminals within a cell (S322). The receiving terminal 132 among the terminals received the receipt paging detects that the call has arrived, and transmits a connection request to the receiving base station 120b (S324). The receiving base station 120b allocates resources to the receiving terminal 132 (S326), and notifies the receiving terminal 132 of a result of resource allocation as a response of the connection request (S328). The receiving base station 120b transmits a response to the call receipt request to the gateway 110 (S330).

The gateway 110 checks the locations of the calling terminal 131 and the receiving terminal 132, and determines whether the terminals 131 and 132 are located within the same cell, or are located within a direct propagation distance range in different cells (S332). When either one of these two conditions is satisfied, the gateway 110 notifies the calling base station 120a and the receiving base station 120b that the terminals 131 and 132 are connected (S334 and S336), thereby requesting that the calling base station 120a and the receiving base station 120b instruct the calling terminal 131 and the receiving terminal 132 to perform the direct communication. Then, the calling base station 120a and the receiving base station 120b respectively notify the calling terminal 131 and the receiving terminal 132 of the connection, thereby instructing the terminals 131 and 132 to perform the terminal-to-terminal direct communication (S338 and S340). In this case, the gateway 110 may add information on whether the connection exists between the two terminals and information on the opponent terminal to the connection notification messages that are transmitted to the calling base station 120a and the receiving base station 120b.

When receiving the connection notification message from the gateway 110, the calling terminal 131 directly transmits a connection attempt message for the direction communication to the receiving terminal 132 within a certain time (S342). The receiving terminal 132, on receiving the connection attempt message, directly transmits a connection response message to the calling terminal 131 (S344). Then, the terminals 131 and 132 switch to a terminal-to-terminal direct communication state to be capable of directly transmitting or receiving user traffic. While it has been shown in FIG. 3 that the calling terminal 131 directly transmits the connection attempt message to the receiving terminal 132, the receiving terminal 132 may transmit the connection attempt message to the calling terminal 131 after receiving the connection notification message from the gateway 110, and the calling terminal 131 may transmit a response to the connection attempt message such that the terminals 131 and 131 can switch to the terminal-to-terminal direct communication state. As a result, the terminals 131 and 132 directly transmit or receive the user traffic without using the base stations 120a and 120b (S346).

When the communication is closed, either one of the terminals 131 and 132 releases the connection (S348 and S350). For example, for closing the direct communication, the calling terminal 131 may transmit a connection release request message to the receiving terminal 132 (S348), and the receiving terminal 132 may transmit a connection release response message to the calling terminal 131 (S350). Alternatively, for closing the direct communication, the receiving terminal 132 may transmit the connection release message to the calling terminal 131, and the calling terminal 131 may transmit the connection release response message to the receiving terminal 132.

While it has been described in FIG. 3 that the calling base station 120a and the receiving base station 120b are separately formed, the calling base station 120a and the receiving base station 120b may be a single base station when the calling terminal 131 and the receiving terminal 132 are located in one cell as shown in FIG. 1. While it has been described in FIG. 3 that the terminal 131 or 132 directly communicates with the base station 120a or 120b, the terminal 131 or 132 may communicate with the base station 120a or 120b via a communication apparatus such as a relay (not shown).

As such, according to an embodiment of the present invention, the user traffic can be directly transferred between the terminals although the control signals such as the connection establishment message are transmitted via the base station. As a result, the load due to an increase of user traffic can be reduced in the mobile communication network, and the CAPEXs and OPEXs for the mobile communication network can be reduced. Further, the user traffic can be transferred between the terminals without passing through the mobile communication network such that a communication service can be cost-effectively served to the terminals. Furthermore, battery usage can be reduced by the terminal-to-terminal direction communication.

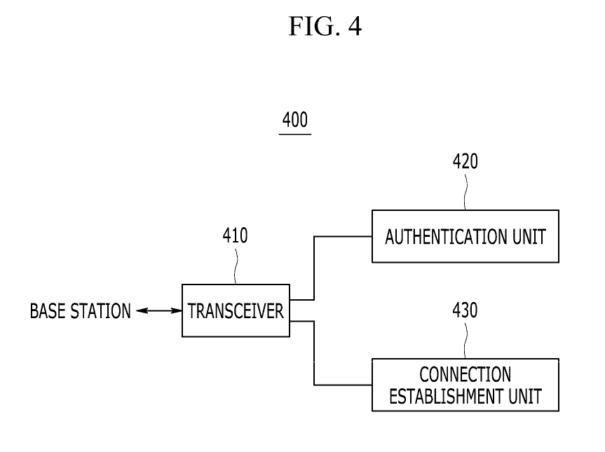

Next, a traffic control apparatus for performing a traffic control method according to an embodiment of the present invention will be described with reference to FIG. 4. The traffic control apparatus may be a gateway 110 shown in FIG. 1 to FIG. 3, or may be formed in the gateway 110.

FIG. 4 is schematic block diagram showing a traffic control apparatus according to an embodiment of the present invention.

Referring to FIG. 4, the traffic control apparatus 400 includes a transceiver 410, an authentication unit 420, and a connection establishment unit 430.

The transceiver 410 receives a request for authentication and position check of a calling terminal and a receiving terminal from a calling base station, and transmits a request for a call receipt to a receiving base station. The transceiver 410 receives a response to the call receipt from the receiving base station, and notifies the calling base station and the receiving base station that the calling terminal and the receiving terminal are connected.

The authentication unit 420 authenticates the calling terminal and the receiving terminal according to the request for authentication of the calling terminal and the receiving terminal.

The connection establishment unit 430 checks locations of the calling terminal and the receiving terminal to determine whether the two terminals are located within the same cell, or whether the two terminals are located within a direct propagation distance range in different cells. The connection establishment unit 430 determines whether to perform the terminal-to-terminal direct communication according to the determined result.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling traffic in a traffic control apparatus of a mobile communication network, the method comprising:
checking locations of a calling terminal and a receiving terminal;
determining whether to perform a terminal-to-terminal direct communication based on the locations of the calling terminal and the receiving terminal; and
requesting a first base station of the calling terminal and a second base station of the receiving terminal that the first base station and the second base station respectively instruct the calling terminal and the receiving terminal to perform the terminal-to-terminal direct communication when determining to perform the terminal-to-terminal direct communication.

2. The method of claim 1, wherein determining whether to perform the terminal-to-terminal direct communication comprises determining to perform the terminal-to-terminal direct communication when the calling terminal and the receiving terminal are located in a same cell.

3. The method of claim 2, wherein the first base station and the second base station are the same base station.

4. The method of claim 1, wherein determining whether to perform the terminal-to-terminal direct communication comprises determining to perform the terminal-to-terminal direct communication when the calling terminal and the receiving terminal are located in different cells and are located within a direct propagation distance range.

5. The method of claim 1, wherein requesting the first base station and the second base station comprises:
transmitting information on the receiving terminal to the first base station; and
transmitting information on the calling terminal to the second base station.

6. The method of claim 5, further comprising:
receiving a request for authentication and location check of the calling terminal and the receiving terminal from the first base station; and
transmitting a request for a call receipt to the second base station.

7. The method of claim 1, wherein user traffic between the calling terminal and the receiving terminal is directly transmitted between the calling terminal and the receiving terminal without passing through the first base station and the second base station when the terminal-to-terminal direct communication is performed.

8. A method of controlling traffic in a terminal of a mobile communication network, the method comprising:
transmitting a request for a connection with a receiving terminal to a base station;
receiving an instruction for terminal-to-terminal direct communication from the base station;
switching to a terminal-to-terminal direct communication state by exchanging messages for the terminal-to-terminal direct communication with the receiving terminal; and
directly transmitting or receiving user traffic to or from the receiving terminal without using the base station.

9. The method of claim 8, where the instruction is transmitted when a gateway of the mobile communication network determines to perform the terminal-to-terminal direct communication based on locations of the terminal and the receiving terminal.

10. The method of claim 9, wherein the terminal-to-terminal direct communication is determined to be performed when the terminal and the receiving terminal are located in a same cell or when the terminal and the receiving terminal are located in different cells and are located within a direct propagation distance range.

11. The method of claim 8, wherein receiving the instruction comprises receiving information on the receiving terminal.

12. The method of claim 8, wherein switching to the terminal-to-terminal direct communication state comprises:
transmitting a connection attempt message for the terminal-to-terminal direct communication to the receiving terminal; and
receiving a response message to the connection attempt message from the receiving terminal.

13. The method of claim 8, wherein switching to the terminal-to-terminal direct communication state comprises:
receiving a connection attempt message for the terminal-to-terminal direct communication from the receiving terminal; and
transmitting a response message to the connection attempt message to the receiving terminal.

14. The method of claim 8, further comprising:
transmitting a connection release message for the terminal-to-terminal direct communication to the receiving terminal; and
receiving a response message to the connection release message from the receiving terminal.

15. The method of claim 8, further comprising:
receiving a connection release message for the terminal-to-terminal direct communication from the receiving terminal; and
transmitting a response message to the connection release message to the receiving terminal.

16. An apparatus for controlling traffic in a mobile communication network, the apparatus comprising:
a connection establishment unit configured to check locations of a calling terminal and a receiving terminal, and to determine whether to perform terminal-to-terminal direct communication based on the locations of the calling terminal and the receiving terminal; and
a transceiver configured to request a first base station of the calling terminal and a second base station of the receiving terminal that the first base station and the second base station respectively instruct the calling terminal and the receiving terminal to perform the terminal-to-terminal direct communication when the connection establishment unit determines to perform the terminal-to-terminal direct communication.

17. The apparatus of claim 16, wherein the connection establishment unit determines to perform the terminal-to-terminal direct communication when the calling terminal and the receiving terminal are located in a same cell.

18. The apparatus of claim 16, wherein the connection establishment unit determines to perform the terminal-to-terminal direct communication when the calling terminal and the receiving terminal are located in different cells and are located within a direct propagation distance range.

19. The apparatus of claim 16, wherein the transceiver is further configured to transmit information on the receiving terminal to the first base station, and transmit information on the calling terminal to the second base station.

20. The apparatus of claim 16, wherein user traffic between the calling terminal and the receiving terminal are directly transmitted between the calling terminal and the receiving terminal without passing through the first base station and the second base station when the terminal-to-terminal direct communication is performed.
